(19) United States
(12) Patent Application Publication
(10) Pub. No.: US 2008/0281675 A1
(43) Pub. Date: Nov. 13, 2008

(54) Electronic Media Systems and Methods

(76) Inventor: Jack K. Zhang, Ijamsville, MD (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/099,136

(22) Filed: Apr. 7, 2008

Related U.S. Application Data
(60) Provisional application No. 60/922,236, filed on Apr. 7, 2007.
(60) Provisional application No. 60/959,059, filed on Jul. 11, 2007.

(51) Int. Cl. G06Q 10/00

(52) U.S. Cl. 705/10

(57) ABSTRACT

Methods and systems of presenting media content targeted to at least one predetermined natural person are provided. Methods and systems for controlling the distribution of media content based on service provider profile data of a service provider are provided. Methods and systems for controlling the provision of media content for presentation to customers at locations of service providers are provided.

The present application claims the benefit of U.S. provisional patent application No. 60/922,236 filed Apr. 7, 2007 in the name of Jack K. Zhang and U.S. provisional patent application No. 60/959,059 filed Jul. 11, 2007 in the name of Jack K. Zhang. Each of U.S. provisional patent application No. 60/922,236 and U.S. provisional patent application No. 60/959,059 is hereby incorporated herein by reference in its entirety.

Methods and systems for presenting media content targeted to at least one predetermined natural person are provided. Methods and systems for controlling the distribution of media content are provided. Methods and systems are provided for controlling the provision of media content for presentation to customers at locations of service providers.

### BACKGROUND

Electronic media can be divided into two groups: mass media, such as broadcast TV or radio, and individualized media, such as media streamed and played on a computer. Mass media can reach a large number of audiences simultaneously with the distinctive advantage of being passive and easy to use. Because of its low cost per delivery compared to individualized media (streaming, for example), it can be easily adopted by a large segment of the population. The main shortcoming of traditional mass-media is that it is unable to deliver precision-targeted content to an audience. Streaming media, a prime example of individualized media, has the ability to reach individuals at a time and location when he/she is interested. However, the higher cost of individualized delivery and the lack of a mechanism that predicts the particular interest of its audience at any moment have limited its application for individualized media delivery to computers and mobile devices. Because TV is a familiar and low-cost media interface to the general population and is both passive and easy to use, it would be advantageous if it were somehow possible to ensure the delivery of TV-type media with the precision achievable with individualized media.

### DISCLOSURE

For this application, the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of corresponding information in a different physical form or forms.

The terms “media content” and “media” as used herein mean data presented as one or more of static images, moving images, sound and text, as well as data that can be used by a presentation device to produce one or more thereof. Examples of media content and media include television programs and advertisements, videos, web pages, audio programs, and so on.

The term “presentation device” as used herein shall mean a device capable of presenting one or more of static images, moving images, sound and text to a natural person based on media content received by such device.

The term “database” as used herein means an organized body of related data, regardless of the manner in which the data or the organized body thereof is represented. For example, and not by way of limitation, the organized body of related data may be in the form of a table, a map, a grid, a packet, a datagram, a frame, a file, an e-mail, a message, a document, a list or in any other form.

The term “network” as used herein includes both networks and internetworks of all kinds, including the Internet, and is not limited to any particular network or inter-network.

The terms “first,” “second,” “primary,” and “secondary” are used herein to distinguish one element, set, data, object, step, process, function, activity or thing from another, and are not used to designate relative position, arrangement in time or relative importance, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communications relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

The terms “communicate” and “communicating” as used herein include both conveying data from a source to a destination, and delivering data to a communications medium, system, channel, network, device, wire, cable, fiber, circuit, and/or link to be conveyed to a destination. The term “communications” as used herein includes one or more of a communications medium, system, channel, network, device, wire, cable, fiber, circuit and link.

The term “message” as used herein includes data to be communicated, in communication or which has been communicated.

The term “processor” as used herein means processing devices, apparatus, programs, circuits, components, systems and subsystems, whether implemented in hardware, software or both, and whether or not programmable. The term “processor” as used herein includes, but is not limited to one or more computers, hardwired circuits, signal modifying devices and systems, devices and machines for controlling systems, central processing units, programmable devices and systems, field programmable gate arrays, application specific integrated circuits, systems on a chip, systems comprised of discrete elements and/or circuits, state machines, virtual machines, data processors, processing facilities and combinations of any of the foregoing.

The term “clinic” as used herein means a facility that natural persons visit to receive health care services and/or to obtain health care products. For example, and not by way of limitation, the term clinic includes doctors' offices, hospitals, community healthcare facilities, pharmacies, medical supply stores and the like.

The terms “storage” and “data storage” as used herein mean data storage devices, apparatus, programs, circuits, components, systems, subsystems and storage media serving to retain data, whether on a temporary or permanent basis, and to provide such retained data.

The term “visit reason data” as used herein means data representing a purpose, motivation, cause or impetus for a visit of a natural person to a location of a service provider. For example, and not by way of limitation, in the case of a patient visiting a clinic, the visit reason data may represent a complaint, diagnosis symptom, procedure, injury, illness, or the like.

The term “service provider profile data” as used herein means data representing one or more of (1) a nature of a service or services provided by a service provider, (2) a profile or profiles of natural persons that use or may use the services of a service provider, (3) visit reason data of natural persons who use or may use the services of a service provider, and (4) brand preferences of a service provider.

The term “player” as used herein means a device or resource that controls a presentation device to present content media to one or more natural persons in accordance with a play list. For example, and not by way of limitation, a player may be a host on a network in communication with a presentation device to control it, or it may be a virtual machine running on a presentation device or on a host that performs additional functions.

A method of presenting media content targeted to at least one predetermined natural person is provided. The method comprises obtaining media content associated with media content identification data and with first visit reason data for a natural person to visit the location of the service provider; obtaining visit data comprising visit time data representing a time for an visit of a natural person at the location of the service provider and second visit reason data for the visit of the natural person; automatically matching the first visit reason data with the second visit reason data; automatically producing presentation time data representing a predetermined time for presenting the media content to the natural person based on the matching of the first visit reason data with the second visit reason data and on the visit time data; and presenting the media content for the natural person with the use of a presentation device at the location of the service provider based on the presentation time data.

A system for presenting media content targeted to at least one predetermined natural person is provided. The system comprises at least one input for obtaining media content associated with media content identification data and with first visit reason data for a natural person to visit the location of the service provider, and visit data comprising visit time data representing a time for a visit of a natural person at the location of the service provider and second visit reason data for the visit of the natural person; a processor coupled with the at least one input to receive the first visit reason data, the visit time data and the second visit reason data and operative to match the first visit reason data and the second visit reason data; the processor being further operative to produce presentation time data representing a predetermined time for presenting the media content to the natural person based on the matching of the first visit reason data with the second visit reason data and on the visit time data; and a presentation device coupled with the processor and controlled thereby based on the presentation time data to present the media content for the natural person at the location of the service provider.

A method of controlling the distribution of media content is provided. The method comprises obtaining media content identification data identifying predetermined media content and associated with first service provider profile data; obtaining service provider identification data identifying a plurality of service providers and second service provider profile data associated with the service provider identification data; automatically matching the first service provider profile data with data within the second service provider profile data associated with a respective one of the plurality of service providers to produce destination data associating the media content identification data with service provider identification data of the respective one of the plurality of service providers; and, automatically based on the destination data, communicating a message to a media content server requesting it to communicate the predetermined media content for delivery to the location of the respective one of the plurality of service providers.

A system for controlling the distribution of media content is provided. The system comprises at least one input for obtaining media content identification data identifying predetermined media content and associated with first service provider profile data and service provider identification data identifying a plurality of service providers and second service provider profile data associated with the service provider identification data; a processor coupled with the at least one input to receive the first service provider profile data and the second service provider profile data and operative to match the first service provider profile data with data within the second service provider profile data associated with a respective one of the plurality of service providers to produce destination data associating the media content identification data with service provider identification data of the respective one of the plurality of service providers; and communications coupled with the processor to receive the destination data and operative in response to the destination data to communicate a message via a network to a media content server requesting it to communicate the predetermined media content for delivery to the location of the respective one of the plurality of service providers.

A method for controlling the provision of media content for presentation to customers at locations of service providers is provided. The method comprises communicating identification data identifying available media content and preview data of such media content to a service provider; receiving an acceptance message from the service provider including acceptance data indicating that the service provider is willing to accept of the media content; and, automatically in response to the acceptance data, communicating an instruction message to a media content server instructing the media content server to communicate the media content to the service provider.

A system for controlling the provision of media content for presentation to customers at locations of service providers is provided. The system comprises at least one communications coupled with a network to communicate identification data identifying available media content and preview data of such media content to a service provider via the network and to receive an acceptance message from the service provider via the network including acceptance data indicating that the service provider is willing to accept of the media content; and a processor coupled with the at least one communications to receive the acceptance message and operative to process the acceptance message to produce control data; the processor being operative to supply the control data to the communications to control the communications to communicate an instruction message to a media content server instructing the media content server to communicate the media content to the service provider.

Certain embodiments of the methods and systems are presented in the following disclosure in conjunction with the accompanying drawings, in which:

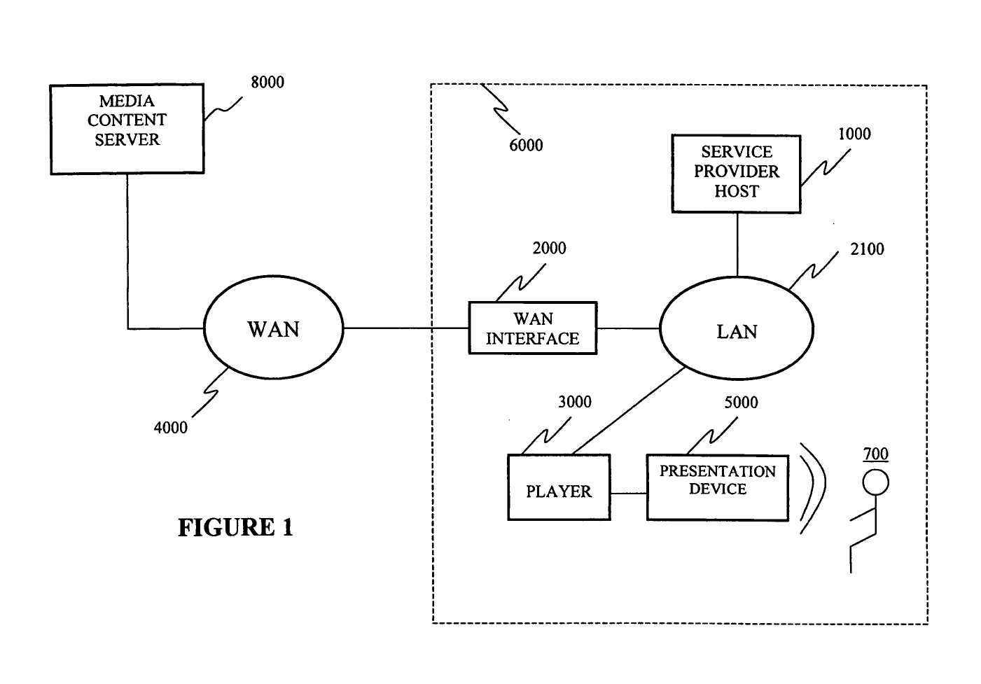

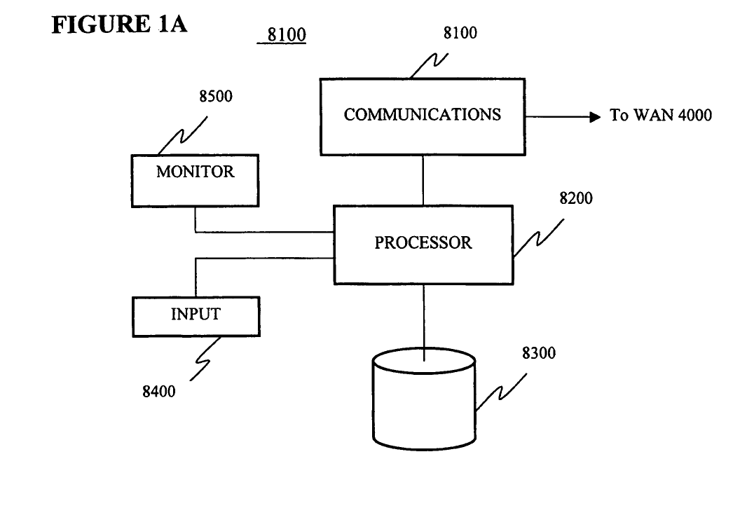

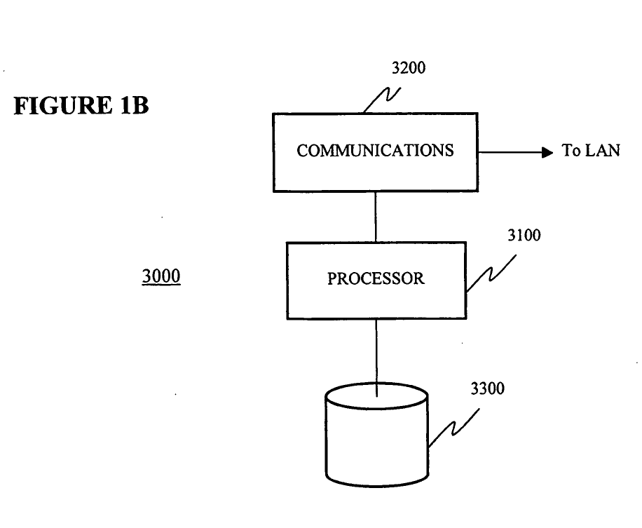

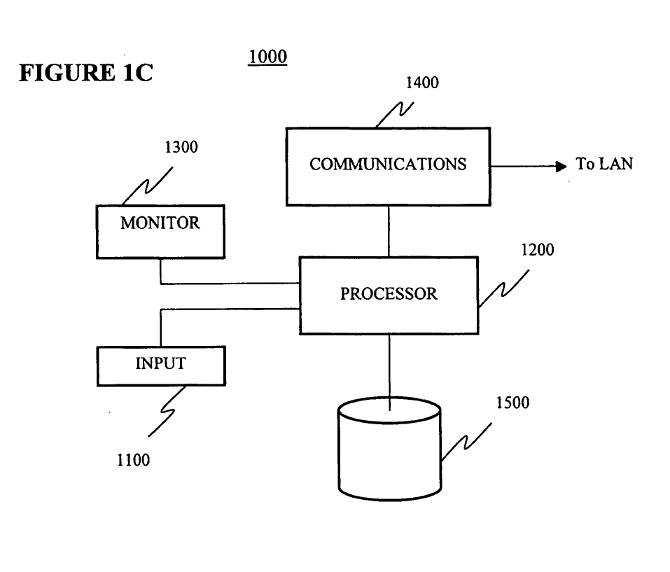

FIG. 1 illustrates embodiments of systems for distributing, scheduling and presenting media content to a natural person having an appointment with a service provider;

FIG. 1A illustrates a media content server of the embodiment of FIG. 1;

FIG. 1B illustrates a player of the embodiment of FIG. 1;

FIG. 1C illustrates a service provider host of the embodiment of FIG. 1;

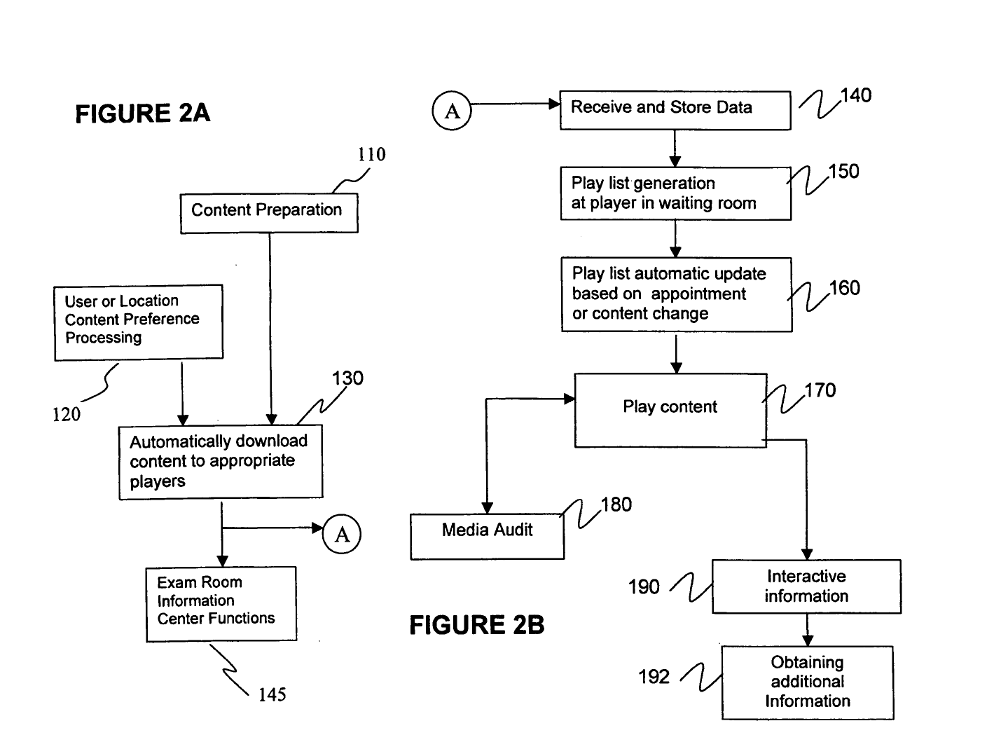

FIGS. 2A and 2B illustrate processes carried out by means of the systems of FIG. 1;

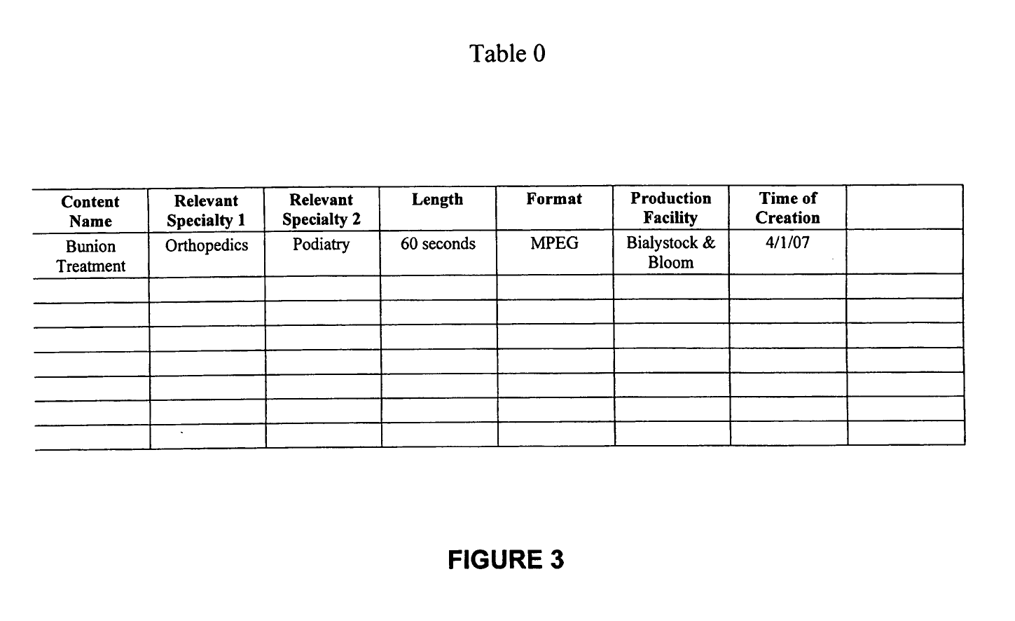

FIGS. 3, 4, 5 and 6 illustrate tables of data produced and/or maintained by means of the systems of FIG. 1;

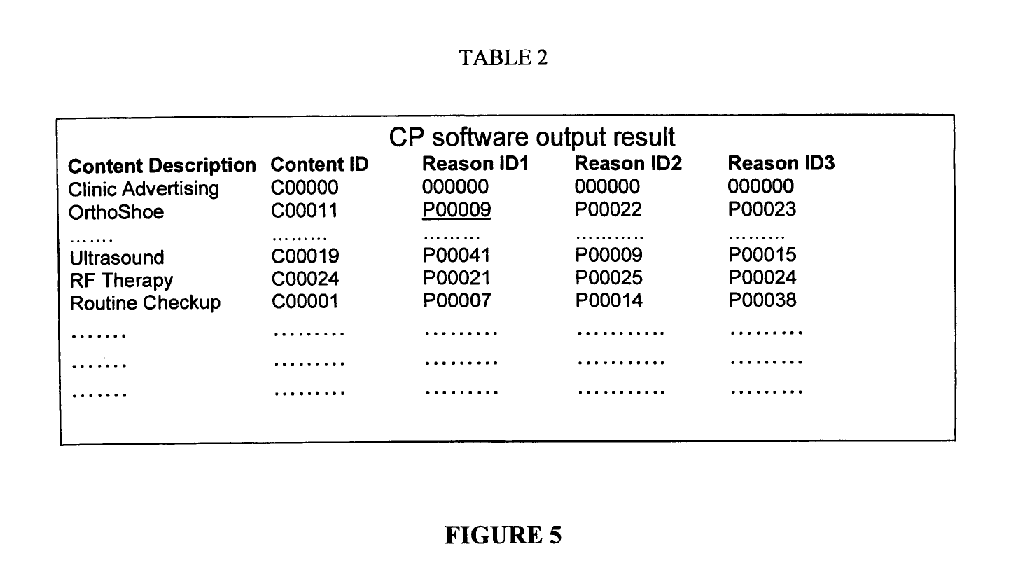

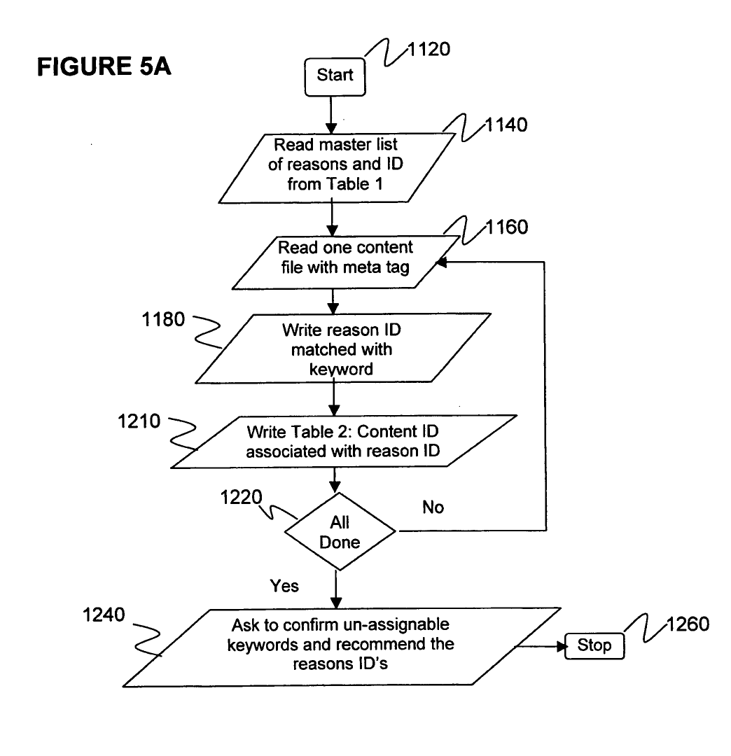

FIG. 5A illustrates a process carried out by means of the systems of FIG. 1;

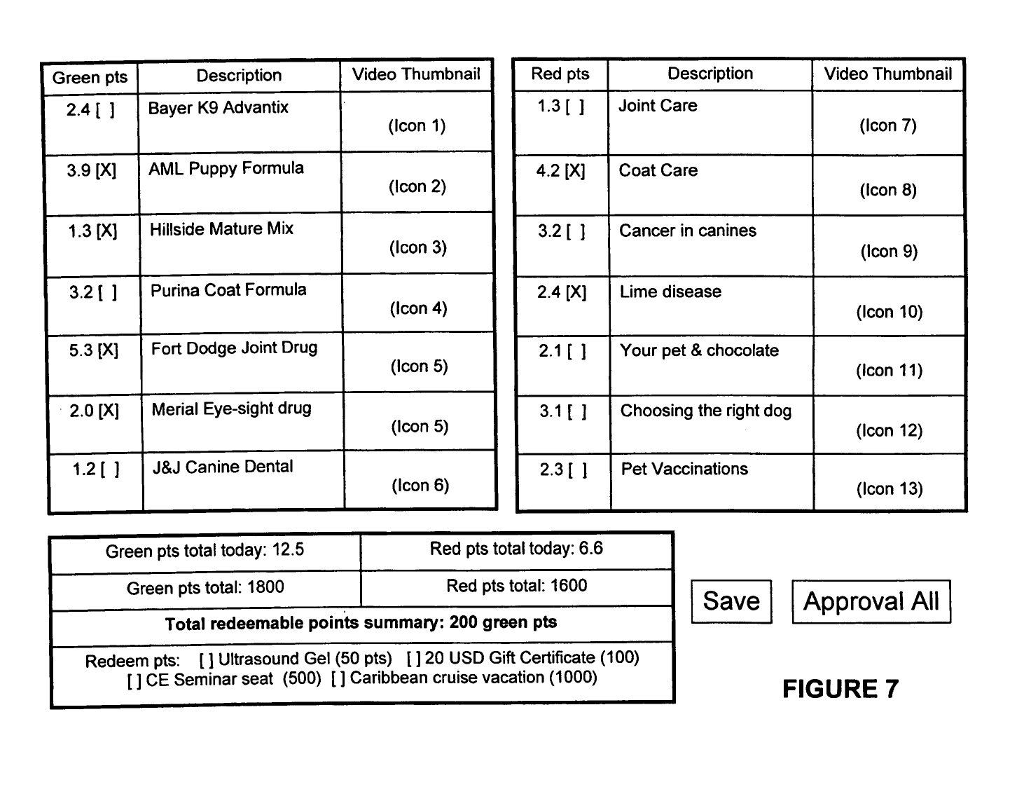

FIG. 7 illustrates a document used for selecting content in the system of FIG. 1;

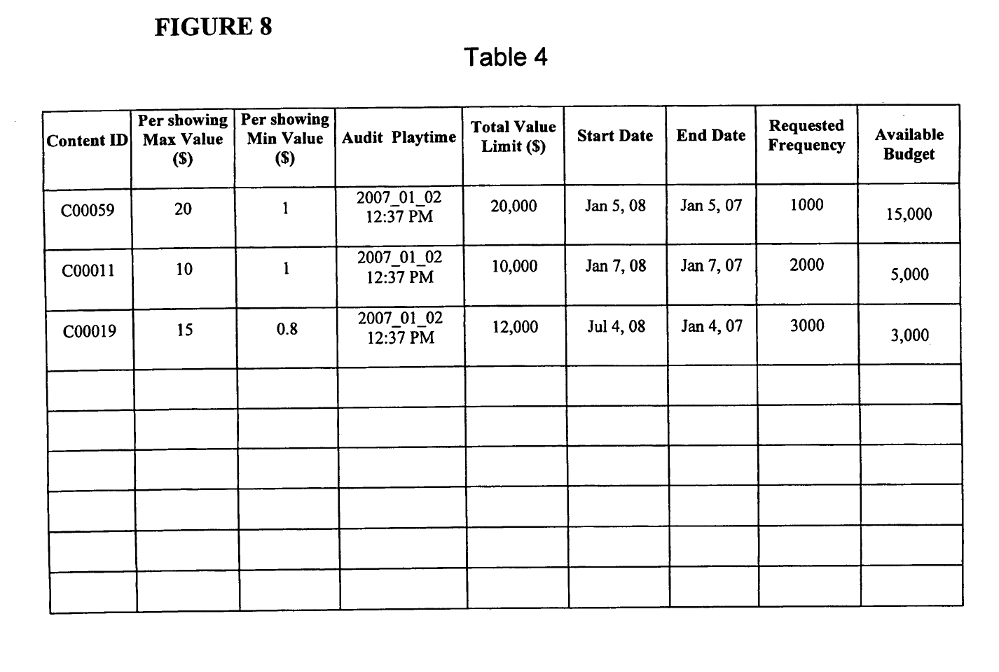

FIGS. 8 through 11 illustrate tables of data produced and/or maintained by means of the systems of FIG. 1;

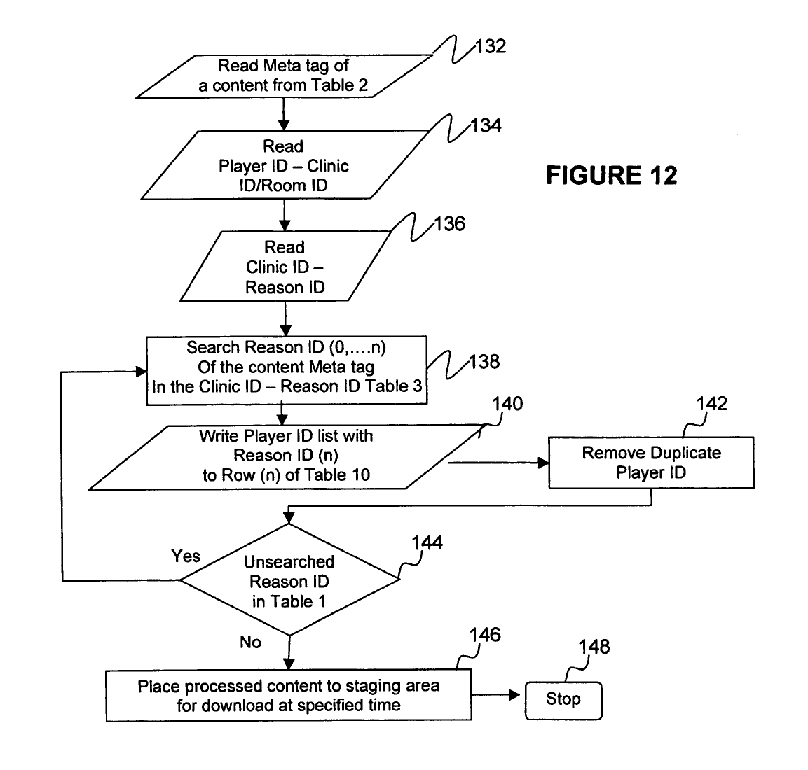

FIG. 12 illustrates a process carried out by means of the systems of FIG. 1;

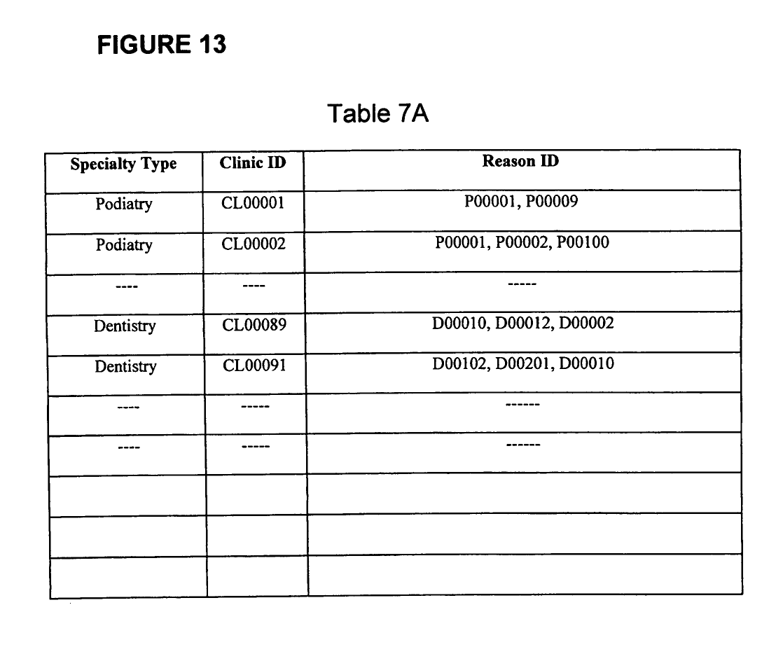

FIGS. 13 through 16 illustrate data or tables of data produced and/or maintained by means of the systems of FIG. 1;

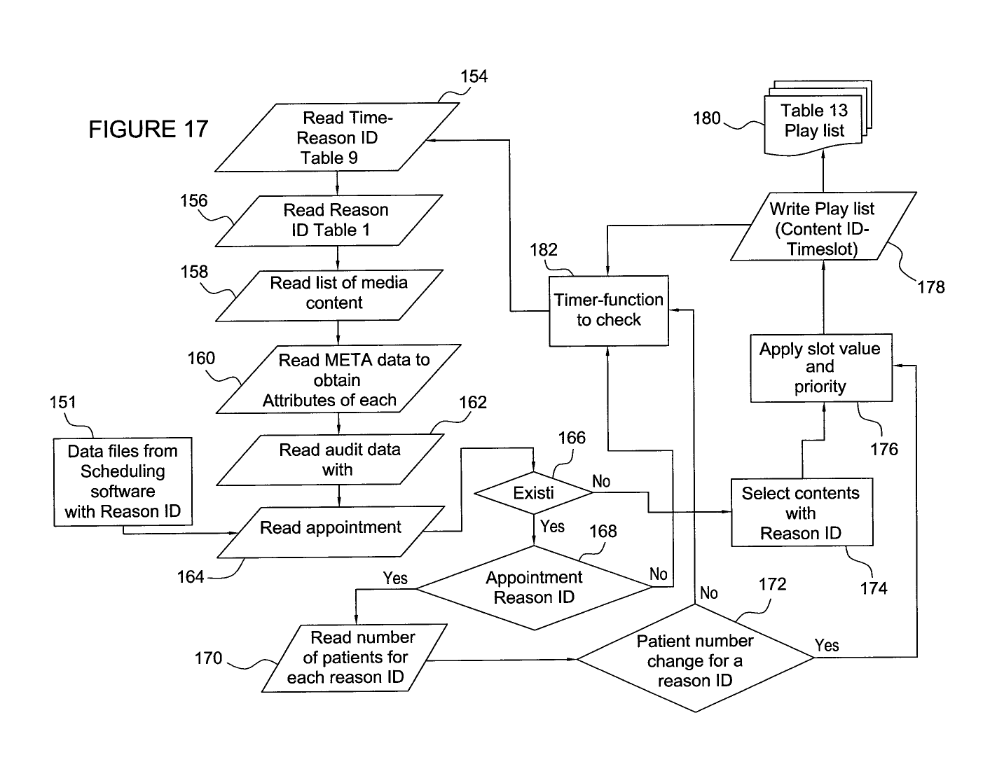

FIG. 17 illustrates a process carried out by means of the systems of FIG. 1;

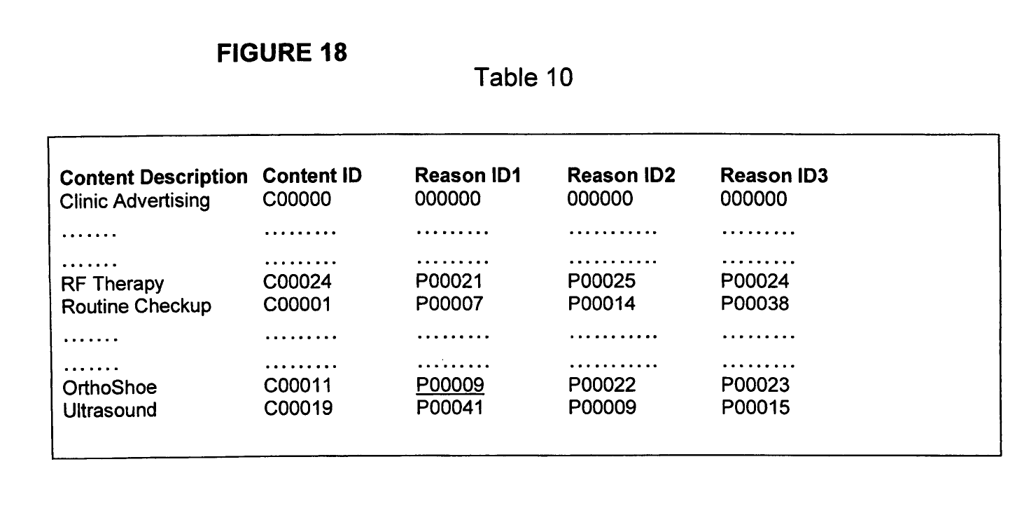

FIGS. 18 through 21 illustrate tables of data produced and/or maintained by means of the systems of FIG. 1; and

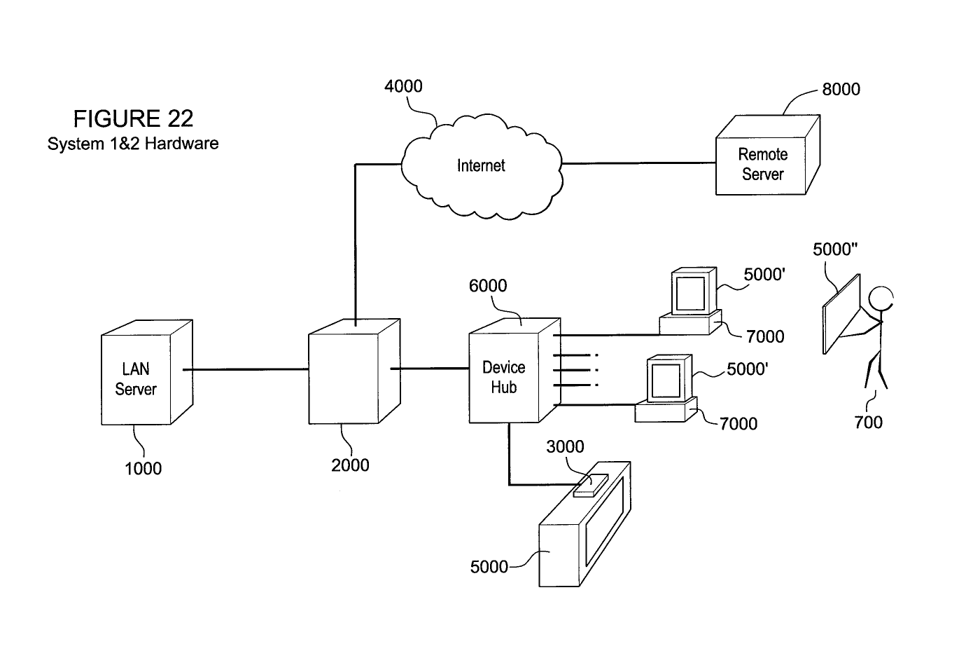

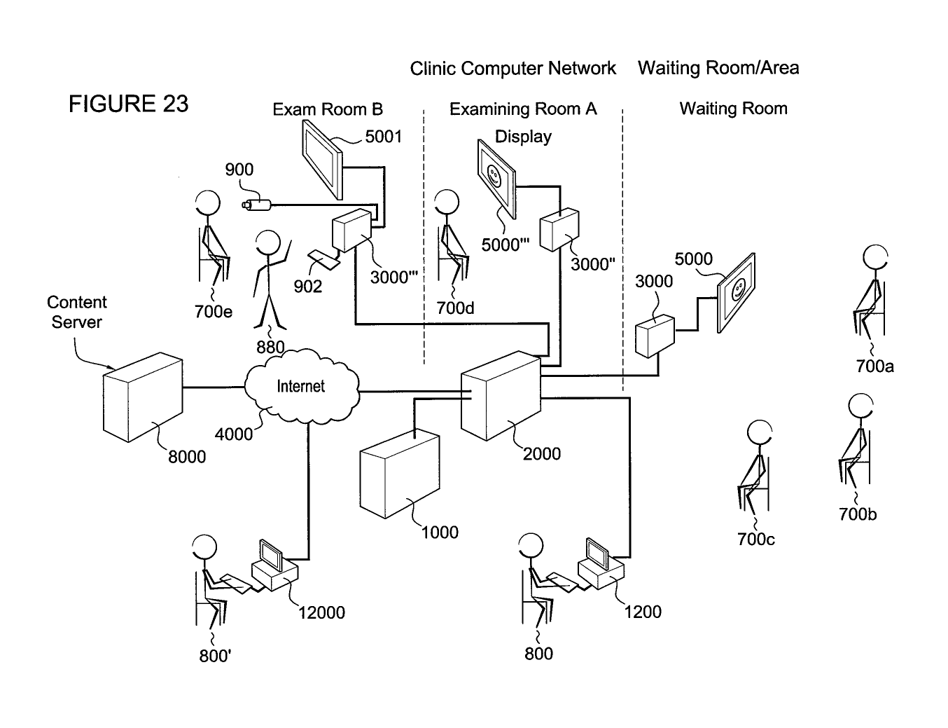

FIGS. 22 and 23 illustrate additional embodiments of systems for distributing, scheduling and presenting media content to a natural person having an appointment with a service provider.

Media content is automatically and efficiently scheduled and presented to customers of service providers present at their locations for predetermined reasons, based on the particular reasons for the customers' presence. For example, when a patient makes an appointment with a clinic at a certain location and at a predetermined time for a specific reason (e.g., heel pain), data indicating the time and reason for the scheduled visit is entered in a scheduling computer of the clinic. This data is accessed by a play list generator host that matches the data indicating the reason for the appointment with reason data associated with particular media content available at the clinic, and produces a play list scheduling the particular media content to be presented for viewing by the patient via a presentation device (e.g., a television) in a waiting room of the clinic at or just before the time of the patient's appointment. In this manner, media content of particular interest to the patient at that time and place can be targeted for presentation to the patient.

Existing content delivery systems produce and update play lists at a content server facility, such as the head end of a cable television system. The systems and methods herein, however, produce and update play lists locally where the content is to be presented, This enables automatic play list generation without server intervention.

The systems and methods herein also avoid the need for advertising managers to intervene and continuously create and update a play list that is individualized for each of a large number of service locations and presentation devices at such locations. They likewise provide the ability to reach a large audience at the same time without the active involvement of the audience members, making it possible for anyone to see or hear messages just like watching television. Nevertheless, the message is highly individualized and targeted, which is most desirable from the vantage of advertisers, and most relevant and interesting to the audience members themselves.

As noted above, one application of the methods and systems herein is in the waiting rooms of medical clinics. In the United States, according to Nielsen Media Research, the average wait time in a doctor's office is 30 minutes. Further, for every 11,000 clinics, there are more than 11,000,000 patient visits per month. That is 5,500,000 patient-hours that could be used to disseminate educational information to the patients. With hundreds of thousands of clinics in the U.S. alone, an electronic media delivery system with the ability to deliver content to thousands of locations simultaneously with individualized targeting ability and cost efficiency, would take advantage of millions of hours of patients' waiting time to provide opportunities for health education of particular interest to patients.

However, the systems and methods herein are also useful in other types of venues where services are provided by appointment, such as automobile service facilities, spas, hair stylists, nail salons, and the like.

FIG. 1 illustrates certain embodiments of a system for distributing, scheduling and presenting media content to customers of a service provider at a location 6000. The media content is distributed from a media content server 8000 located remotely from the location 6000 via a wide area network (WAN) 4000, such as the Internet or a telecommunications network such as the public switched telephone network or other data communications facility. A wide area network (WAN) interface 2000 at the location 6000 provides a gateway to the WAN 4000 for a local area network (LAN) 2100 at the location 6000.

A service provider host 1000 at the location 6000 is coupled with the LAN 2100 and provides administrative functions for the service provider, including scheduling visits or appointments of natural persons to the location 6000 to receive services and/or products from the service provider. In certain ones of such embodiments, the service provider comprises a clinic and host 1000 provides functions for the operation of the clinic, including scheduling, patent billing and EMR (electronic medical record or electronic health record) management. A player 3000 at the location 6000 is coupled with the LAN 2100 and is also coupled with a presentation device 5000 to control it in accordance with play list data stored in the player 3000 to present media content to a natural person 700 visiting the service provider's location 6000 to obtain services and/or products.

FIGS. 2A and 2B illustrate the operation of the embodiments of FIG. 1. As indicated at 110 in FIG. 2A, media content is prepared for distribution by server 8000. With reference also to FIG. 1A, which illustrates certain embodiments of the content server 8000, in greater detail, under the communications 8100 thereof receives data representing files of various content from content producers, such as advertisers and producers of educational programs. The received files, that typically include data such as metatags and other data associated with media content contained therein, are stored in storage 8300 of server 8000 under the control of a processor 8200, and automatically assigned a content ID thereby. FIG. 3 illustrates an exemplary table of such metatags and other data that may accompany such a content file when received by server 8000.

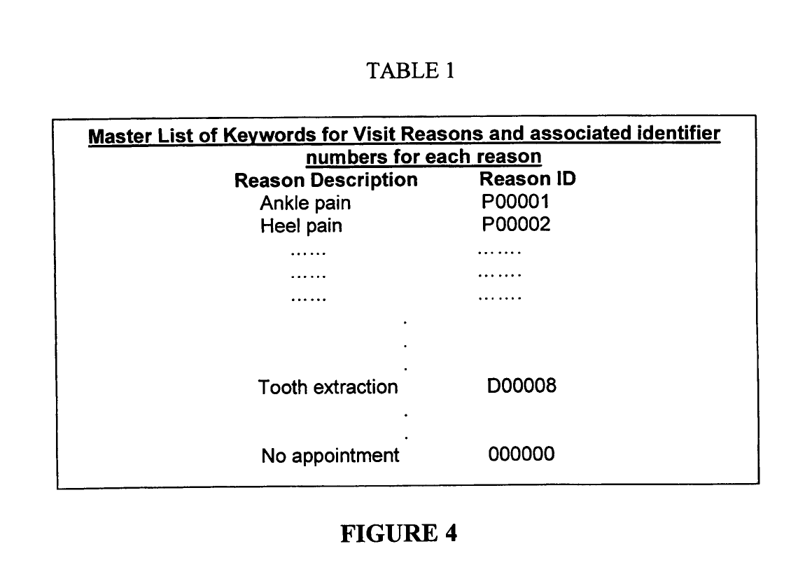

By means of an input 8400 coupled with processor 8200, and while monitoring the server's operation by means of a monitor 8500, when a content file is received, a human operator will then populate an attribute field of the file with keywords that will serve to characterize the content. For example, a file including video content showing a new anti-inflammatory medication will be assigned with keywords such as, tooth infection, foot infection, arthritis, inflamed bowel, tendonitis, etc. The server will assign service provider profile data (including visit reason data) that associates to each of the keywords in the attributes of the file identified by the content ID. This is performed automatically by processor 8200 based upon data stored in a table obtained thereby from storage 8300. An example of such a table illustrated as Table 1 in FIG. 4. By reference to the exemplary Table 1 of FIG. 4, processor 8200 assigns “Reason ID's” to the file by matching its keywords with the “Reason Descriptions” shown in Table 1. As a result of this process, processor 8200 updates a table that stores identifications of the various media content files stored in storage 8300 in association with the various Reason ID's obtained by reference to Table 1. An example of such a table is illustrated in FIG. 5 as Table 2.

An exemplary process for populating Table 2 as described above is illustrated in FIG. 5A. The process begins 1140 when processor 8200 reads the master list of reasons and Reason IDs from Table 1 of FIG. 4 stored in storage 8300. Each content file has a META tag for keeping attributes related to this content. When content files are created and stored in storage 8300, each is given a list of keywords in the META tag. The keywords from the META tag of each file are read, 1160, by processor 8200. Then processor 8200 matches 1180 each keyword with a Reason ID and writes, 1210 the Reason ID into the META tag of the corresponding file along with the keywords.

For each batch of content files to be downloaded, the processor 8200 process 1210 each in that fashion and writes the results in Table 2 until all content files to be processed in this batch are complete. For content files with keywords that are not identified by any existing reason ID and keywords association in Table 1, processor 8200 will present 1240 those contents and keywords to a human operator for clarification. Then the system stops the software awaiting for next time when is needed.

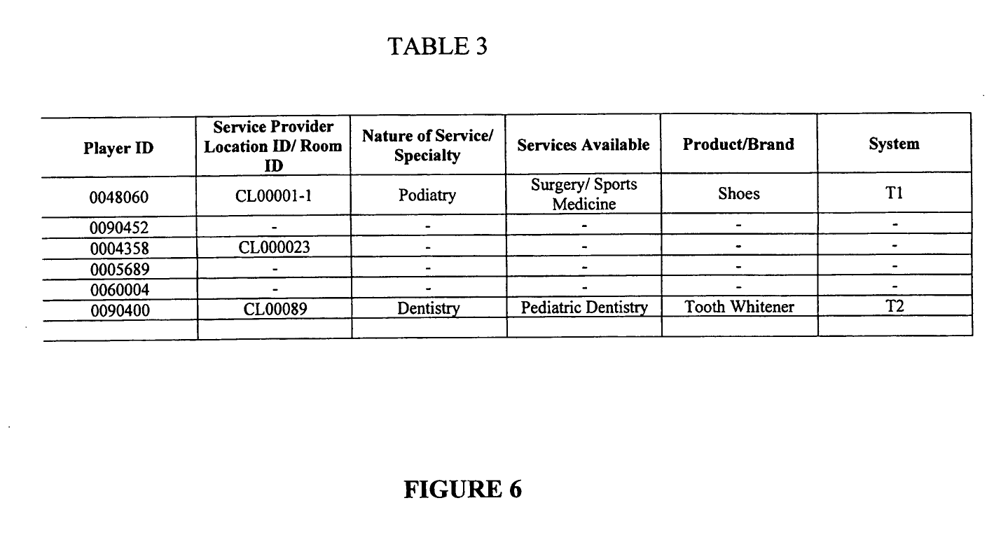

In order to obtain data for determining the relevance of available content files for each service provider, service provider personnel are interviewed to obtain data that characterizes their organizations. This data is stored in a table such as Table 3 shown in FIG. 6. More specifically, each service provider is assigned data that identifies it and its particular location (if it has more than one location), indicated as a Service Provider Location ID in Table 3, as well as particular rooms within the location where content is to be presented. As will be seen from FIG. 6, as a result of the interview, for each service provider, data is obtained and stored in Table 3 indicating the nature of the service rendered thereby (e.g., podiatry, dentistry, automotive repair, etc.), various services provided to customers, patients, clients, or the like, and types of products supplied as a result of or ancillary to the service, along with preferred brands thereof.

In certain embodiments, a human interface, shown in FIG. 7, is provided for service provider personnel to approve or reject content made available for download from server 8000. The interface is communicated from server 8000 via WAN 400 to the service provider host 1000, as shown in FIG. 1. With reference also to FIG. 1C which illustrates host 1000 in greater detail, the human interface web page of document in certain ones of such embodiments is communicated in a pull-type process in which a human operator at location 6000 enters a request in host 1000 via an input 1100 thereof (such as a keyboard or mouse) to processor 1200 thereof, while referring to a monitor 1300 of host 1000. Processor 1200 responds by controlling communications 1400 to send a message to server 8000 requesting the interface. Server 8000 responds by communicating the interface to communications 1400 from which it is received by processor 1200 which processes the received interface to control monitor 1300 to display the interface in the form as shown in FIG. 7

The interface of FIG. 7, provided, for example, as described above, allows a user to select from at least one category of content. In FIG. 7, there are two columns of content titles, each column containing titles of content files listed with name and description, points associated with that title, a thumbnail that allows visual preview when clicked and a check-off box for registering selection by the interface user. The methodology of the content selection allows the content files to be categorized into at least two categories, green and red, for example. The green category can designate content paid-for by advertisers, while the red category can represent content that are non-sponsored. In each category, points are assigned to each title based various factors, including the length of the content, the cost of sponsorship per unit time (dollars per second), and desired rate of distribution. For example, a file titled AML Puppy Formula is a 180 second video with a sponsorship cost of 36,000 dollars to be shown 720,000 times starting in one week has 3.9 green points; where as a content titled Hillside Canine Dental is a 90 second video with a sponsorship cost of 18,000 dollars to be shown 360,000 times starting in four weeks has 1.3 green points. An exemplary algorithm and method for deriving point value for green content category considers the parameters including M, value per showing ($/show), r, seasonality and/or frequency (show/day), T, length of the content, and R, number of people reached, in a formula as follows:

# of Green points=(F1*M*r*R)/T,

wherein F1 is an empirically derived factor.

An exemplary formula for deriving red points employs factors T, the length of the content, C, cost to acquire content, and S, seasonality, as follows:

Red points=F2*T*C*S

By selecting the points as shown in the example illustrated by FIG. 7, a clinic administrator has selected multiple files with green points totaling 12.5 and red points totaling 6.6 for that selection episode. This exemplary methodology keeps track of green and red points accumulated from such selection activities including each episode as well as all episodes for the clinic in the aggregate. For example, assume that the total green points accumulated by this clinic has reached 1800, while the red points has reached 1600 points. Each type of points can be designated to a specific reward structure. The green points can be used to provide rewards to the clinic while the red points can be used to keep track of fees or subscription dues for selecting non-sponsored content by a clinic.

In certain embodiments, the system assigns equal value to green and red points. The system also designates the green points as the points useful for reward redemption; the red points as indication of service fees due to selecting non-sponsored content. The net points as well as the color associated to the net points can be used as an incentive to guide the clinic in selecting titles with more green points, or a balanced selection of green and red titles so the points cancel each other out, to result in free service to the clinic. When the net points are green, the system applies the green points to rewards of various kinds, for example, merchandise priced with a matching number of green points.

As an alternative to the pull method described above, while server 8000 is in communication with host 1000, it pushes a web page interface to host 1000 which pops up on its monitor 1300 to indicate the availability of new content available for download.

With reference again to FIGS. 1C and 7, by selecting a check-off box associated with a content title, the operator instructs processor 1200 to control communications 1400 to communicate a message to server 8000 to register a selection of a corresponding file, record the points assigned to the selection and tally the amount of total points from the current selection activities.

When server 8000 receives a request for download from a service provider, as explained above, it prepares a table of data to be used in managing the files to be downloaded. An example of such a table is shown in FIG. 8 as Table 4. Each row of Table 4 represents a different file to be downloaded and at the time of download, data is stored in the table representing the content ID to identify the file, along with maximum and minimum values to charge per showing of the content in the file (the amount charged can vary, for example, depending on the number of persons available at that time to view the content), the total value limit (or total amount that the sponsor is willing to pay for showing its content, e.g., an advertisement), the start date for showing the content and the end date for showing it, the requested frequency (the number of times it can be shown) and the available budget (the amount remaining after deductions for previous showings of the content from the total value limit).

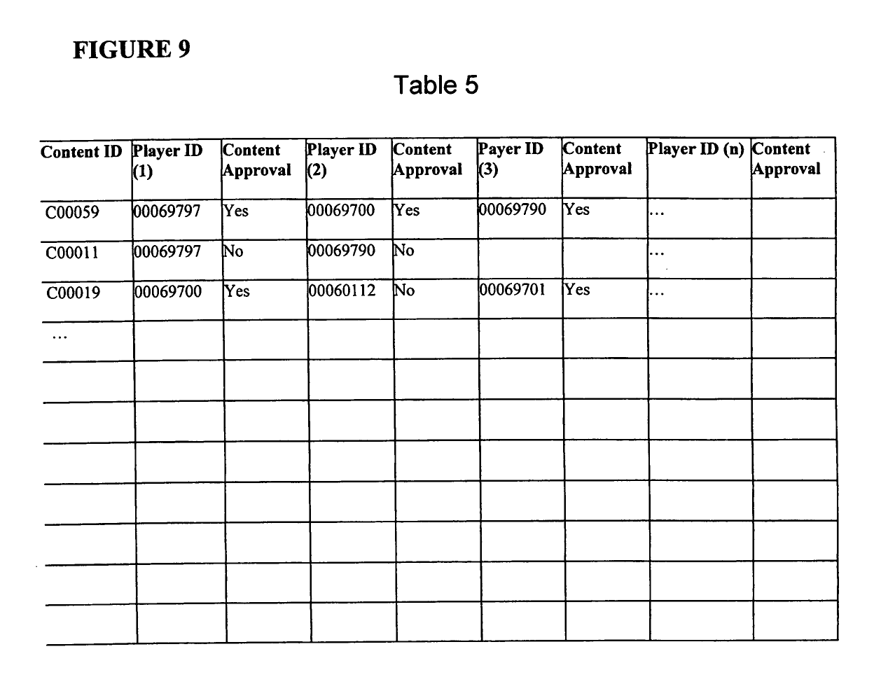

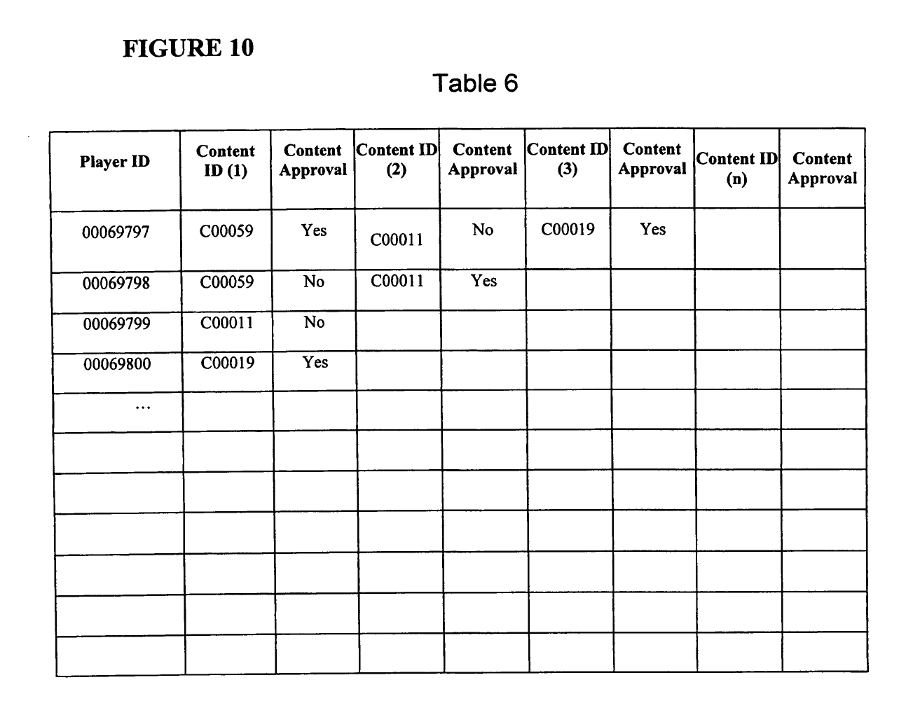

Based on the requests received from the service providers, server 8000 prepares a table indexed by content ID indicating the players to which approved content is to be downloaded, and those for which download was denied. An example of such a table is included as Table 5 in FIG. 9. In addition, based on such requests server 8000 also prepares a table indexed by player indicating the content for which download to such player has been approved, as well as for which download of corresponding content has been denied. An example of such a table is included as Table 6 in FIG. 10.

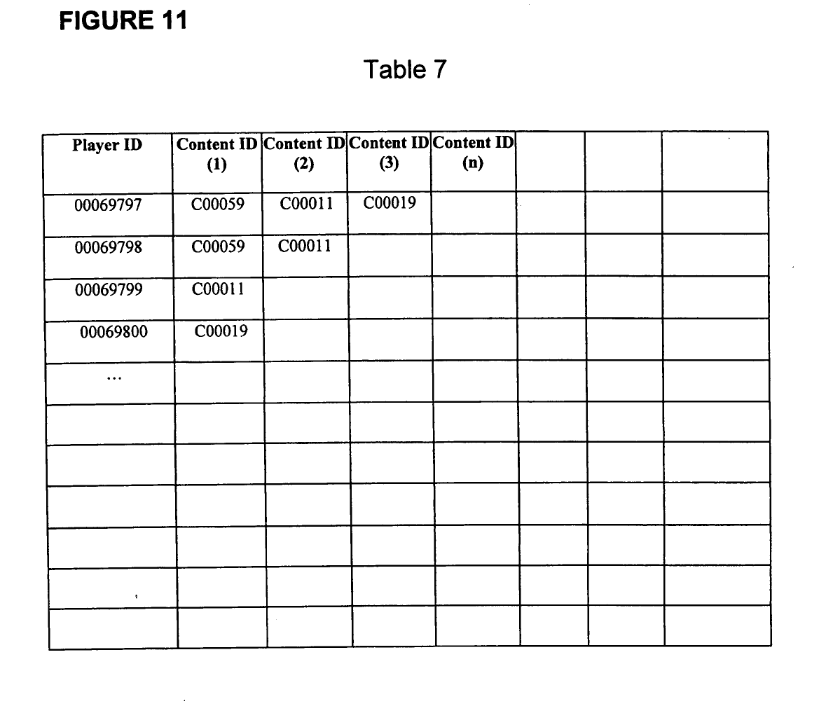

In order to download the selected files, server 8000 populates a table indexed by player ID and identifying the content files to be downloaded thereto as well as an appropriate address for the player, such as an IP address, MAC address or the like. An example of such a table is shown as Table 7 in FIG. 11 (in which destination addresses have been omitted for simplicity and clarity).

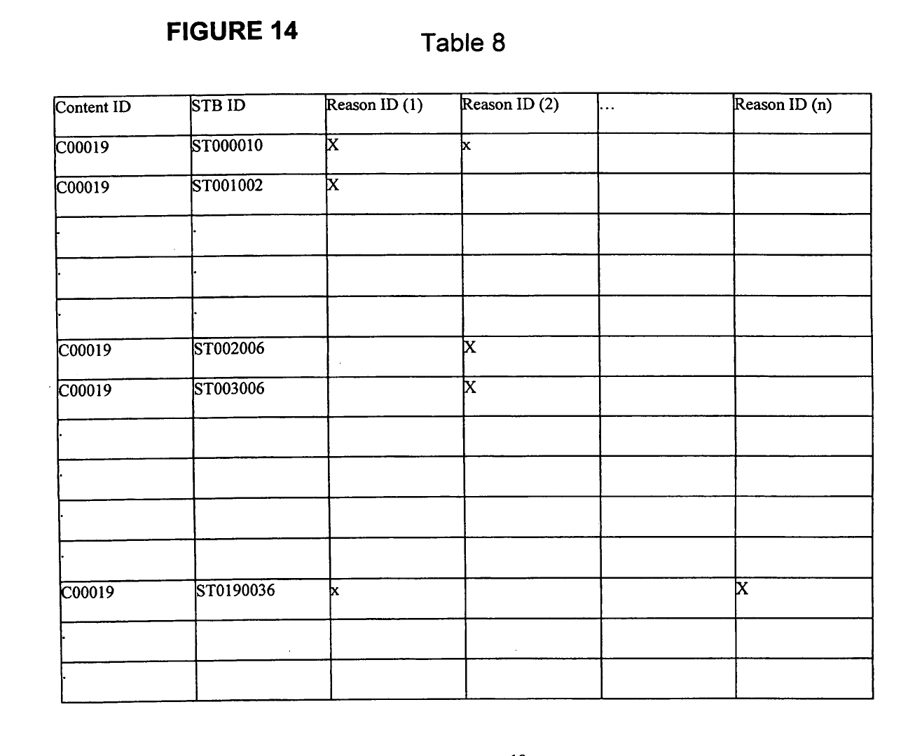

FIG. 12, illustrates processing of content files for downloading to each player and execute the downloading process. Processor 8200 reads 132 a META tag with the Reason ID of a content file being processed from Table 2, and then reads 134 Table 3 to obtain existing player ID's and clinic-exam-room ID's. Processor 8200 further reads 136 a list of clinic ID's associated with multiple Reason ID's kept in a Table 7A illustrated in FIG. 13 which is manually complied based on information obtained from the various service providers. During the next phase 138, processor 8200 will take one reason ID at a time, search through Table 7A for each clinic ID, then Table 3 for the player ID associated with the clinic ID, and write the player ID with the reason ID into a Table 8 illustrated in FIG. 14. The processor will remove any duplicate player ID's in Table 8 each time it writes a player ID into it. The processor will repeat this process for the next reason ID in the META tag of the content file until all Reason IDs processed. The resulting Table 8 will serve as an address book for a batch of content files to be automatically downloaded.

With reference to FIG. 2B, the content files downloaded from server 8000 in certain embodiments are stored 140 in player 3000, which is illustrated in greater detail in FIG. 1B. As shown in FIG. 1B, player 3000 comprises a processor 3100 which receives the downloaded content files from communications 3200 via LAN 2100 and controls storage 3300 to store the downloaded files for later presentation by presentation device 5000.

In certain embodiments, player 3000 is combined with a WAN interface into one device with capability of (1) accepting downloaded content over the WAN 4000 (e.g., the Internet), (2) storing the downloaded content, (3) generating a play list based on information residing on host 1000 and/or its components, (4) initiate and continue a series of media playing events with content stored on the player 3000, (5) delivering video and audio signal to the presentation device 5000. In certain embodiments, player 3000 is combined with a presentation device, so that a separate presentation device 5000 is not required.

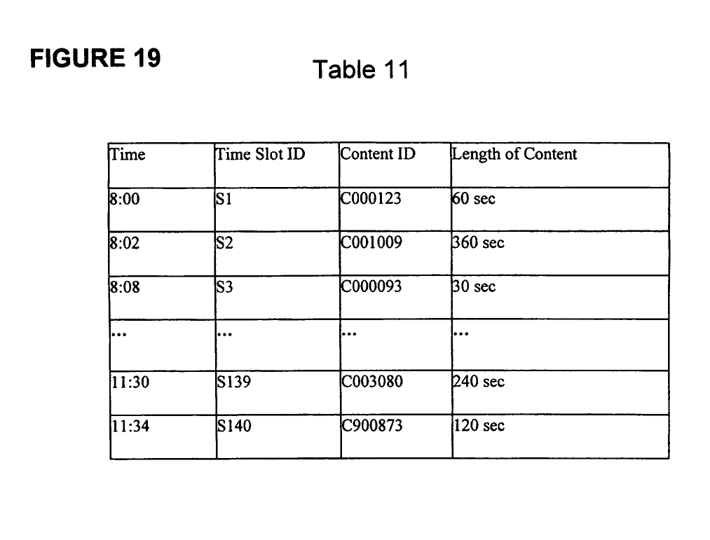

Play list production and management functionality is implemented by player 3000, by another host on the LAN 2100 or else by a host coupled to WAN 4000 and automatically generates a play list according to one of the following scenarios. (1) When a schedule of customer, patient or client visits or appointments is available on host 1000 or elsewhere and includes visit reason data for the visits or appointments, a play list with content associated with the visit reason data will be generated to match a designated reason ID associated with designated content ID. (2) When the schedule of visits or appointment is incomplete (e.g., visit reason data is missing), a play list for time segments with missing or incomplete appointment information is produced using content that is assigned with the highest requested frequency by the advertiser or content with value that is requested by an advertiser to air during undesignated time slots. (3) The system also plays content that is for general education in a specific specialty related to the services provided at the location. This content will be used to fill time slots that are not directly related to a specific visit or appointment. An example of a play list appropriate for use in the disclosed systems and methods is provided as Table 11 in FIG. 19.

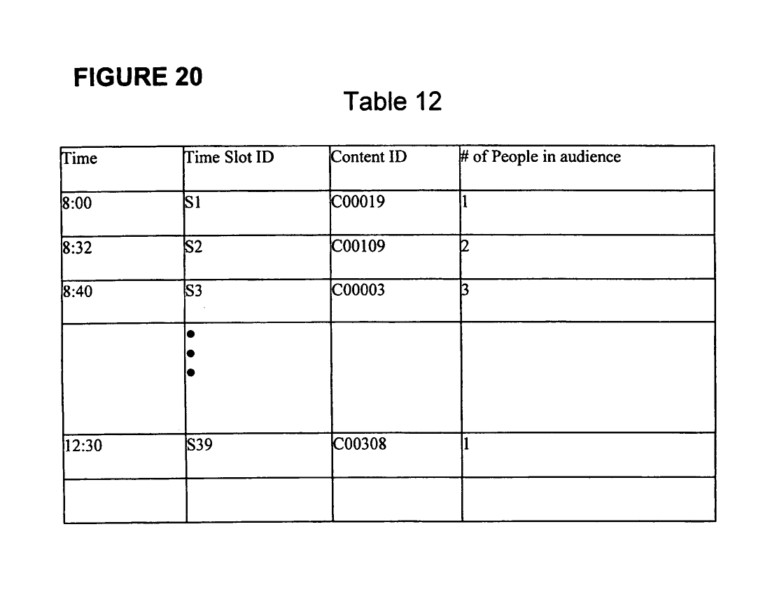

Each play list will be stored after it is played for media effectiveness measurement and audit. In certain embodiments, data is saved in audit files for this purpose. An exemplary table of audit data is illustrated as Table 12 in FIG. 20.

With reference again to FIG. 2B, in embodiments in which play list generation is carried out by player 3000 in step 150, player processor 3100 retrieves reason IDs from the content downloaded and stored in storage 3300. It will also collect reason IDs generated by the scheduling host on LAN 2100 via communications 3200 and process the received data to associate the reason IDs carried in the content to an appointment or visit with an identical reason ID. Once an identical reason ID is detected in the appointment data, the player software will try to locate content files with the same reason ID stored on the player and compile a play list in accordance with the time of the appointment.

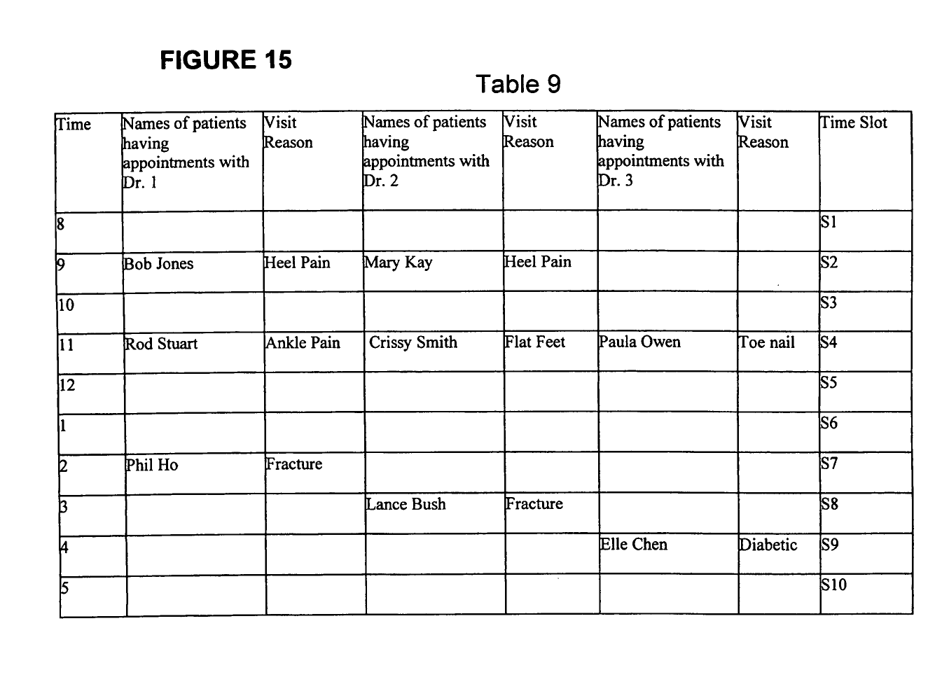

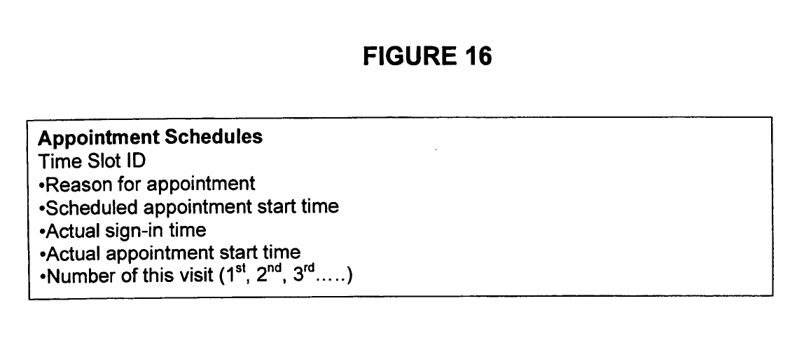

An example of scheduling data that may be available from a given scheduling host is illustrated as Table 9 in FIG. 15. In order to avoid any possibility of compromising the privacy of the customers, patients or clients whose names appear in the scheduling data of Table 9, player 3000 is configured to extract only the data identified in FIG. 16 for purposes of producing the play list. Rather than use a name to identify the data set shown in FIG. 16, a time slot ID is assigned to it which contains no information from which the person's name may be derived or accessed.

In certain embodiments, a play list generation process is carried out as illustrated in FIG. 17. The data as indicated in FIG. 16 is read 154 from Table 9 in FIG. 15. The keywords read in this manner are matched with Reason ID's read 156 from Table 1 of FIG. 3 and a Reason ID is assigned to a particular time when an appointment is scheduled. Then a list of media content files stored on the player 3000 is read 158 from Table 10 illustrated in FIG. 18. Further, the metadata of the content files in Table 4 of FIG. 8 are read 160 to obtain attributes of such media content files. Additionally, the software will read 162 into the memory any audit data from Table 12 of FIG. 20 so that it can be determined whether each of the content files is to be played or deleted. The data as indicated in FIG. 16 are read 164 from files 151 maintained by the scheduling host.

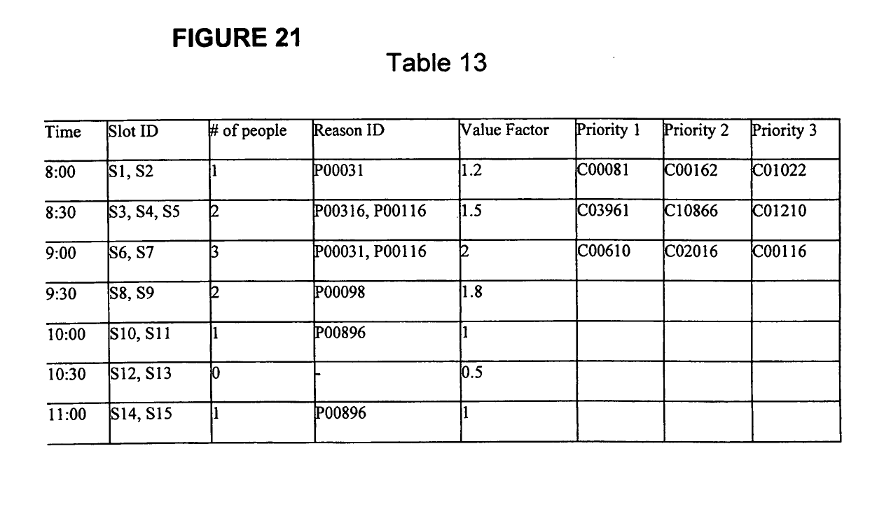

Then it is determined 166 whether or not a play list already exists. If it does not exist, it means a new list is to be created, and content is selected 174 based on a Reason ID that matches a Reason ID for an appointment in a timeslot as indicated by the data obtained from the files 151. A timeslot value is applied 176 to further select from multiple content files bearing the reason ID by matching the timeslot value to a content file with the closest designated value-per-showing, based on data maintained in a Table 13 of FIG. 21. The player 3000 or other device that generates and maintains the play list produces the data of Table 13 by applying one or more priority determining rules to the content files available for play. For example, the files with the highest play frequency remaining may be given priority over others with lower frequency values. Another appropriate priority rule gives priority to files having higher play values (i.e., which yield the greatest revenue from advertisers when played). The play list is written in the form of a content-timeslot association in Table 11.

After the play list is created, a timer function 182 for a specific preset delay is carried out, fifteen minutes for example. The timer is designed to allow the software to be in a pause mode while awaiting for anticipated changes or updates to the appointment schedule.

If there is an existing play list, as determined in 166, the steps 154 through 162 are carried out, and then it is determined 168 whether there is a change in a particular timeslot that involves a reason ID change. If there is no reason ID change for an appointment, the timer pause mode 182 is entered.

If there is a reason ID change as determined at 168, it is determined 172 whether there has been a change in the number of patients with the same reason ID for the timeslot. If there is no change to the number of patients bearing a specific reason ID, the pause mode with timer is entered 182. If there are changes occurred to the number of patients during a time associated to a reason ID, a new value is applied 176 to the time slot and the play list is updated 178.

FIG. 22 illustrates further embodiments with a presentation device 5000 for displaying videos and player 3000 similar to that was described in connection with FIG. 1. In addition to fixed location monitors, the system of FIG. 2 has the ability to have multiple portable display terminals 5000′. Terminals 5000′ are portable devices capable of displaying video so that an audience member 700′ can bring device 5000′ to a seat in the waiting area and view a personalized media session. In certain ones of such embodiments, portable media terminal 5000′ also functions as a patient appointment check-in device and personal information update device. In such embodiments terminal 5000′ comprises and input device (not shown for purposes of simplicity and clarity) including one or more buttons, switches, keypads cameras, touch-sensitive displays or microphones, that input tactile, image and/or acoustic data indicting the presence of the audience member 700′. Terminal 5000′ communicates presence data based on the input data to network equipment 2000 which dynamically updates the play list based on the presence data so that terminal 5000 and/or terminal device 5000″ will initiate playing content with reason ID relevant to member 700′.

Referring to FIGS. 22 and 23, in certain embodiments a local device hub 6000 is used to manage content delivery from network equipment 2000 to player 3000 and terminal 5000′″. In the exemplary illustration of FIG. 4, the terminal 5000′″ is positioned in a clinic visited by member 700a, b, c and d. When player 3000″ receives information that a clinic staff has led member 700d into an examine room to be seen by a physician, hub 6000 in FIG. 2 or 2000 in FIG. 4 will instruct terminal device 5000″ or 5000 to cease playing additional content with reason ID for appointment by member 700′. At the same time, player 3000″ will start playing content on 5000′″ with content bearing reason ID associated to appointment by member 700d. There are various ways to detect that a person has moved to an examination room from a waiting room, including obtaining data from a clinic's internal patient tracking system, monitoring data entered in the examination room entered by clinic personnel or automatically in connection with an electronic medical record of the person.

FIG. 4 illustrates an implementation of the embodiment of FIG. 2 comprising a server 8000 coupled with the Internet 4000. The Internet is also coupled with a clinic via a communication device 2000 coupled with a file server 1000, computer 1200 used by medical staff 800 of the clinic updating appointment schedule, media player 3000 in clinic waiting room to store and display media content on monitor 5000, for viewing by patients in waiting room, media player and computing device 3000″ in Exam Room A for displaying audience specific content through monitor 5000′″ for viewing by patient 700d in the exam room, media player and computer device 3000′″ in Exam Room B. Computing device 3000′″ coupled with device 2000, is equipped with an imaging device 900, user data input device 902 such as a keyboard or a mouse, to be used by medical staff 880, and is capable of displaying media content on monitor 5001 customized for patient 700e as well as information entered by device 902, and images obtained during the exam by device 900.

As shown also in FIG. 4, the internet also is coupled with computer 12000 for use by clinic staff or service agent 800′ to server 8000 to enable a content selection process that decides which content to be downloaded from server 8000 to media players 3000, 3000″ and 3000′″.

Data for appointments set through computer 12000 will be used by play list software residing either on 3000 or 3000″ or on a server 1000 or resides on a server connected to internet 4000 to generate and update a play list for media sessions shown in the example clinic shown in FIG. 4.

Although various embodiments of the present invention have been described with reference to particular steps and sequences of steps, and to arrangements of parts, features and the like, these are not intended to exhaust all possible steps, sequences, arrangements or features, and indeed many other embodiments, modifications and variations will be ascertainable to those of skill in the art.

What is claimed is:

1. A method of presenting media content targeted to at least one predetermined natural person, comprising: obtaining media content associated with media content identification data and with first visit reason data for a natural person to visit the location of the service provider; obtaining visit data comprising visit time data representing a time for an visit of a natural person at the location of the service provider and second visit reason data for the visit of the natural person; automatically matching the first visit reason data with the second visit reason data; automatically producing presentation time data representing a predetermined time for presenting the media content to the natural person based on the matching of the first visit reason data with the second visit reason data and on the visit time data; and presenting the media content for the natural person with the use of a presentation device at the location of the service provider based on the presentation time data.

2. A system for presenting media content targeted to at least one predetermined natural person, comprising: at least one input for obtaining media content associated with media content identification data and with first visit reason data for a natural person to visit the location of the service provider, and visit data comprising visit time data representing a time for a visit of a natural person at the location of the service provider and second visit reason data for the visit of the natural person; a processor coupled with the at least one input to receive the first visit reason data, the visit time data and the second visit reason data and operative to match the first visit reason data and the second visit reason data; the processor being further operative to produce presentation time data representing a predetermined time for presenting the media content to the natural person based on the matching of the first visit reason data with the second visit reason data and on the visit time data; and a presentation device coupled with the processor and controlled thereby based on the presentation time data to present the media content for the natural person at the location of the service provider.

3. A method of controlling the distribution of media content, comprising: obtaining media content identification data identifying predetermined media content and associated with first service provider profile data; obtaining service provider identification data identifying a plurality of service providers and second service provider profile data associated with the service provider identification data; automatically matching the first service provider profile data with data within the second service provider profile data associated with a respective one of the plurality of service providers to produce destination data associating the media content identification data with service provider identification data of the respective one of the plurality of service providers; and, automatically based on the destination data, communicating a message to a media content server requesting it to communicate the predetermined media content for delivery to the location of the respective one of the plurality of service providers.

4. A system for controlling the distribution of media content, comprising: at least one input for obtaining media content identification data identifying predetermined media content and associated with first service provider profile data and service provider identification data identifying a plurality of service providers and second service provider profile data associated with the service provider identification data; a processor coupled with the at least one input to receive the first service provider profile data and the second service provider profile data and operative to match the first service provider profile data with data within the second service provider profile data associated with a respective one of the plurality of service providers to produce destination data associating the media content identification data with service provider identification data of the respective one of the plurality of service providers; and communications coupled with the processor to receive the destination data and operative in response to the destination data to communicate a message via a network to a media content server requesting it to communicate the predetermined media content for delivery to the location of the respective one of the plurality of service providers.

5. A method for controlling the provision of media content for presentation to customers at locations of service providers, comprising: communicating identification data identifying available media content and preview data of such media content to a service provider; receiving an acceptance message from the service provider including acceptance data indicating that the service provider is willing to accept of the media content; and, automatically in response to the acceptance data, communicating an instruction message to a media content server instructing the media content server to communicate the media content to the service provider.

6. A system for controlling the provision of media content for presentation to customers at locations of service providers, comprising: at least one communications coupled with a network to communicate identification data identifying available media content and preview data of such media content to a service provider via the network and to receive an acceptance message from the service provider via the network including acceptance data indicating that the service provider is willing to accept of the media content; and a processor coupled with the at least one communications to receive the acceptance message and operative to process the acceptance message to produce control data; the processor being operative to supply the control data to the communications to control the communications to communicate an instruction message to a media content server instructing the media content server to communicate the media content to the service provider.
